(19) United States
(12) Patent Application Publication
(10) Pub. No.: US 2019/0190274 A1
(43) Pub. Date: Jun. 20, 2019

(54) AN ENERGY MANAGEMENT SYSTEM AND METHOD FOR GRID-CONNECTED AND ISLANDED MICRO-ENERGY GENERATION

(71) Applicant: Swansea University, Swansea (GB)

(72) Inventor: Meghdad Fazeli, Swansea (GB)

(73) Assignee: Swansea University, Swansea (GB)

(21) Appl. No.: 16/310,320

(22) PCT Filed: Jun. 16, 2017
(86) PCT No.: PCT/GB2017/051763

§ 371 Date: Dec. 14, 2018

(30) Foreign Application Priority Data
Jun. 16, 2016 (GB) 1610503.3
Jul. 15, 2016 (GB) 1612350.7

(51) Int. Cl. H02J 3/38; H02J 3/32; H02J 7/35; H02J 7/00

(52) U.S. Cl. CPC H02J 3/385; H02J 3/32; H02M 7/537; H02J 7/0029; H02J 7/35

(57) ABSTRACT

A micro-grid energy management system is provided which can operate and regulate power, voltage, frequency and phase to a load in both grid-connected and islanded mode, obviating the need for switching between control paradigms.

The present invention is concerned with an energy management system and method for grid-connected and islanded micro-energy generation. In particular, the present invention is concerned with an energy management system and method for “main grid”-connected and islanded micro-grids comprising renewable energy generators.

### INTRODUCTION

Generation of electrical power by renewable means is becoming increasingly common. Decreasing cost of photovoltaic arrays and the use of government subsidies have led to a significant uptake in the installation of solar panels on homes, offices and factories. In addition, solar farms can be established and used to generate power as a commercial undertaking.

In addition to photo-voltaic panels, electricity can be generated on the micro-scale by other means, e.g. small domestic wind turbines. Both are sources of renewable energy, the meaning of which is well understood in the art.

Typically, a country will have a main grid which distributes alternating current electricity at a predetermined voltage, frequency and phase. Such main grids are designed to receive a stable AC electricity feed from e.g. a fossil fuel or nuclear source. The feed from such means of power generators will typically not vary—i.e. they are “synchronous generators”.

Prior art synchronous generators, as their name suggests, are synchronised to the main grid frequency when they are connected. The system that controls frequency is called a governor. The governor monitors the generator's rotor speed (which is proportional to grid frequency) and adjusts the input mechanical power from a prime-mover (such as a steam turbine) according to a droop characteristic. Droop speed control is well known in the art.

For example, if speed drops less than synchronous speed (which means frequency is less than 1 pu) more power is demanded from the prime-mover and vice versa. The same system also controls the frequency in the islanded operation of a prior art synchronous generator. Evidently such governors are not appropriate for renewable sources as the input power of the generator (which could be e.g. incident sunlight or wind speed) cannot be manipulated.

Interfacing renewable sources with the main grid is not straightforward. PV panels produce a DC output which needs to be converted to AC via a solar inverter (DC/AC converter). Such solar inverters must be configured to match the voltage, frequency and phase of the main grid.

Because renewable sources are highly variable in their power output, it is usual to combine them with energy storage (ES) so energy can be stored and used when required. A problem arises in the case where PV panels are combined with ES. ES also provides the operator with the ability to store generated energy and sell it at his or her convenience. Conventionally ES is connected to the AC side of the solar inverter requiring an AC/DC converter to charge the ES. This energy management system can be expensive due to the addition of an AC/DC converter and suffers from limited flexibility in the choice of use, store or sale of the energy generated. Prior art systems do exist with ES upstream of the inverter, but these are series-connected.

Another problem with interfacing PV panels with the main grid is that their output is dependent on the solar radiation incident on the panel surface. The efficiency of the power extraction from the panel is also dependent upon the amount of incident radiation, panel temperature as well as the load attached to the panel. Various techniques which fall within the term “maximum power point tracking” (MPPT) have been used to ensure that the characteristics of the load (controlled electronically) can be set to ensure the maximum power point is utilised.

It is known for a plurality of electricity generators to be connected in a “micro-grid”. A micro-grid typically comprises a plurality of interconnected distributed generation (DG) units (e.g. PV panels) and energy storage (ES) units (e.g. batteries) which can operate in parallel with, or isolated from, the main power grid. Micro-grids can benefit customers through providing uninterruptible power, enhancing local reliability, reducing transmission loss, and supporting local voltage and frequency.

When such micro-grids are islanded (i.e. when the main grid ceases to be operational) the intention is for them to remain operational. To achieve this, micro-grids must be designed such that they can operate in both grid-connected and islanded (i.e. grid-disconnected) modes. Four operating scenarios can be defined for a micro-grid:
grid-connected;
islanded;
transition from grid-connected to islanded; and,
transition from islanded to grid connected.

In grid-connected mode, where voltage and frequency are imposed by the main grid, the imbalance between generated and demanded local active and reactive power will be supplied or absorbed by the grid (depending on whether the imbalance is a power deficit or excess respectively).

In islanded mode, the active and reactive power imbalance must be handled locally. This is usually achieved through using energy storage (ES) systems and auxiliary generators (AG) for active power imbalance, and exploiting the power electronic converters (PEC) of DGs and AGs, to supply/absorb reactive power imbalance. This means that the micro-grid's voltage and frequency must be locally controlled within limits defined by international standards such as IEEE 1547.

In the same way that prior art non-renewable governed generators are frequency matched to the grid, a renewable DG such as a PV panel must be synchronised to grid frequency during grid-connected mode and must be able to control frequency during islanded operation. The common approach in grid-connected mode is to use a Phase Locked Loop (PLL) to synchronise the DG with the grid, while during islanded mode, droop control (as mentioned above) is the most common approach to control voltage and frequency of the microgrid.

Transition from islanded to grid-connected is usually handled through utilisation of a phase locked loop (PLL) in order to synchronise DG units to the grid frequency. Grid connection is always intentional.

However, grid disconnection (islanding) can be either planned (e.g. for maintenance) or unplanned (e.g. due to a fault on the grid side). According to the current regulations, all distributed generation and storage units must be disconnected from the grid within a specified time interval after an islanding event being detected (e.g. within 2 seconds according to IEEE 1547). However, this undermines the whole concept of micro-grid, which must be able to supply local loads (or at least the critical loads) even after being disconnected from the grid. Therefore, a micro-grid must be able to detect an unplanned islanding event in order to switch from grid-connect mode to islanded mode.

Since there are two different control schemes, an islanding detection method is required to detect an unplanned islanding event and switch from grid-connected to islanded control. Since grid reconnection is always planned (unlike grid disconnection which can be either planned or unplanned), it is less problematic. However, still some sort of communication from the grid to the DG is required to change the control back to grid-connected mode i.e. bringing back the PLL in order to get synchronised to grid again.

Islanding detection methods can be categorized into three groups: passive, active, and communication-based.

Passive

In passive method, one or more local parameters are monitored in order to detect an islanding event. Different parameters have been proposed in literature, for example, voltage and frequency, unusual changes of active power and frequency, fast increases in the voltage phase, reactive power, difference in phase angle or Total Harmonic Distortion (THD). However, passive methods suffer from a relatively large non-detection zone (NDZ). NDZ refers to certain area in the active power vs reactive power plane which is associated with very small (non-detectable) variations of voltage and frequency. In other words, a real grid failure may not be detected.

Active

In active methods, a controlled disturbance is injected into the system and islanding being detected according to the response of the system. Although active methods have zero (or very small) NDZ, they might be slower than passive methods (due to the dynamics of the system). In addition, active methods can deteriorate the power quality with the injected disturbance.

Communication-Based

The main disadvantage of communication-based methods is that they fully depend on a fast and reliable communication between the main grid and DGs, which can be very expensive. Furthermore, any communication method can be subject to noise and disruptions that can endanger the operation.

What is required is a micro-grid energy management system which overcomes, or at least mitigates, the aforementioned problems with the prior art.

### BRIEF DESCRIPTION OF THE INVENTION

According to a first aspect of the present invention there is provided an energy management system according to claim 1.

According to a second aspect of the present invention there is provided a method of management according to claim 13.

The present invention method can seamlessly ride-through a fault, control voltage and frequency during islanded operation and seamlessly get synchronised with the grid upon reconnection.

Effectively, the invention mimics the operation of a synchronous generator's AVR and governor utilising the energy storage as a prime mover.

Unlike previous system, the system according to the invention:
Can be augmented to classical current controlled VSC (voltage source converters).
Covers all area related to renewable energy such as energy storage control and maximum power point tracking.
Introduces a comprehensive active and reactive power control that minimises the utilisation of a fossil-fuelled auxiliary generator.
Makes sure that the rating of the converter is not violated due to a high active and/or reactive power.
Is quite “user-friendly” in terms of energy storage control. Hence, the user can decide how much energy store and how much energy sell, at will.

Moreover, the proposed over-charged protection, although is not the necessary part of the control, unlike similar schemes, does not need a dumping resistor to dissipate the generated power.

A comprehensive reactive power management scheme is also introduced that utilises all the available capacity of the distributed generator's converter while making sure that its rating is not violated through supplying/absorbing the remaining load reactive power by the auxiliary generator.

According to a third aspect of the present invention there is provided an energy management system (EMS) for a renewable energy source capable of providing local energy usage, local energy storage and selective feed of either or all of generated and stored energy into a load or to a grid whereby:
a. the EMS comprises a local storage mechanism upstream of the DC to AC converter controlled by a MPPT and energy storage control mechanism; and,
b. the EMS determines in a predetermined manner or by algorithm or by user preference how much energy is stored or used locally or sold to a grid.

Preferably the local energy storage mechanism is connected between the renewable energy source and DC/AC converter in parallel.

Preferably the energy storage mechanism and associated DC/DC converter and controller are configured to undertake MPPT for the renewable energy source.

Preferably the local energy storage comprises a DC to DC converter and a local energy storage device upstream of the DC to AC converter.

The energy storage mechanisms may be electric (e.g. supercapacitors) or mechanical (e.g. flywheels).

The energy storage mechanism can be augmented to the previously existing renewable generation units with minimal alternation and costs.

### DESCRIPTION OF THE DRAWINGS

FIG. 1 is a diagram of a first grid-connected PV panel energy management system according to the present invention;

FIG. 2a is a diagram of the MPPT control system for the system of FIG. 1;

FIG. 2b is a diagram of the operation of the energy management system of FIG. 1;

FIG. 3 is a detail diagram of the DC/AC converter control of the system of FIG. 1;

FIG. 4 is a set of graphs showing the simulated results from the energy management system of FIG. 1;

FIG. 5 is a diagram of a second PV panel energy management system according to the present invention;

FIG. 6a is a diagram of the DC/DC controller of the energy management system of FIG. 5;

FIG. 6b is an energy management scheme of the system of FIG. 5;

FIG. 7 is a detail diagram of the DC/AC converter control of the system of FIG. 5;

FIG. 8 is a diagram of a SRF-PLL;

FIG. 9 is a schematic diagram of the DG's inverter and filter;

FIG. 10 is a simplified schematic of a static AVR system;

FIGS. 11a and 11b are a set of graphs showing the simulated results from the energy management system of FIG. 5;

FIG. 12 is a detail view of a portion of the graphs (f) and (g) of FIG. 11; and,

FIG. 13 is a set of graphs showing ES over-charge protection.

### DETAILED DESCRIPTION

Energy Management System

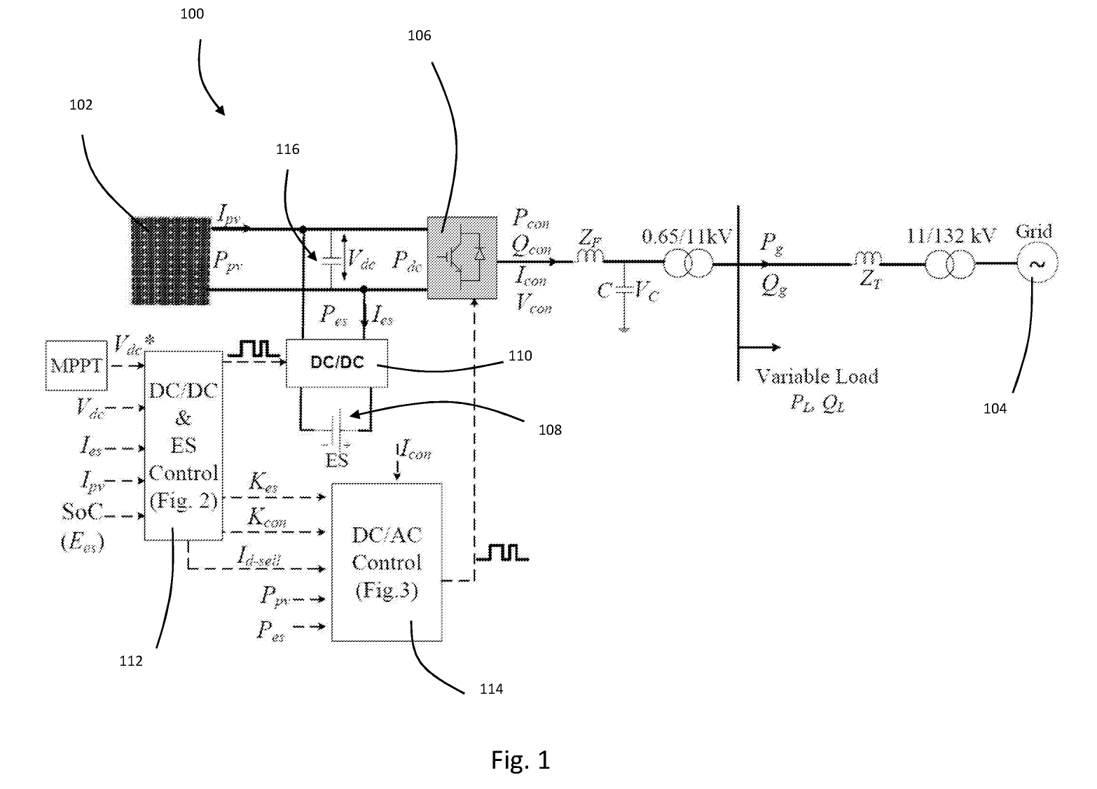

FIGS. 1 to 4 show an energy management system 100 which forms a part of the present invention.

The system 100 is connected to a photovoltaic panel 102 at a first, upstream side and to a main electricity grid 104 at a second, downstream side. The system 100 comprises:
A solar inverter 106;
An energy storage (ES) 108 in the form of a battery;
A DC/DC converter 110 connected in parallel between the panel 102 and the inverter 106;
A first controller 112 controlling the DC/DC converter; and,
A second controller 114 controlling to the DC/AC converter (i.e. the solar inverter 106).

It will be noted that the energy storage 108 (which as discussed is, in the prior art, often located downstream of the inverter 106) is positioned upstream of the inverter 106. In other words, the energy storage 108 is positioned on the DC side of the inverter 106.

Output power 102 (Pₚᵥ) and output current (Iₚᵥ) from the PV panel are captured across a capacitor 116 as a voltage (V_{dc}) which is converted to an appropriate voltage for local storage in the ES 108 by the DC to DC converter 110.

Maximum Power Point Tracking (MPPT) which optimises the dynamically varying Pₚᵥ with the input impedance of the energy management system is conventionally done by the inverter 106. However, in the present system 100, MPPT is undertaken by the DC/DC converter 110 and the first controller 112. The control is such that the power generated by the PV panel 102 is shared/split between (i) power stored locally at the ES 108 (Pₑₛ) and (ii) power to be supplied to the inverter 106 and thereby converted to grid power (P_{dc}). The split is determined according to the state of charge (SoC) of the battery (ES 108), in a manner to optimise power supplied to the load (P_{L}, Q_{L}) and to the grid (P_{g}, Q_{g}). By monitoring the SoC of the ES 108, the locally stored energy can be selectively released to the grid in a controlled manner.

In further detail, the proposed energy management system (EMS) shares the generated PV power Pₚᵥ between the ES (Pₑₛ) and the DC/AC converter (P_{con}≈P_{dc}) according to the SoC of the ES. The proposed EMS therefore provides the owner of the energy harvesting system (commonly known as a distributed grid (DG)) with the ability to sell the stored energy to the grid according to the SoC.

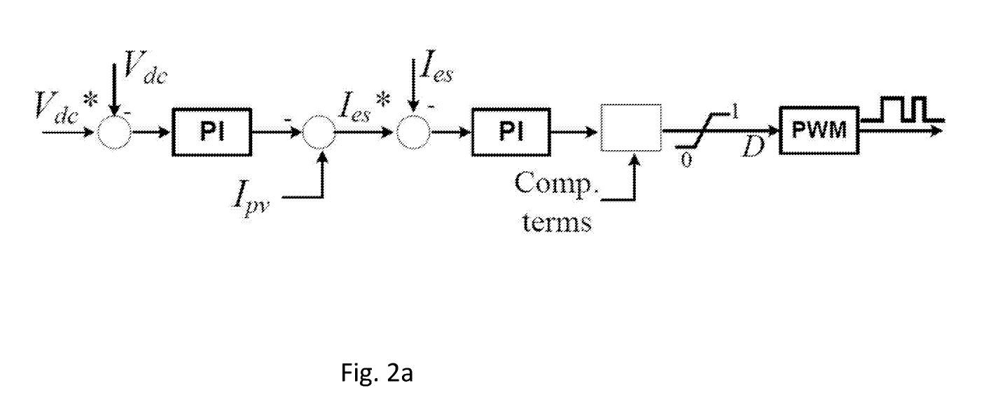

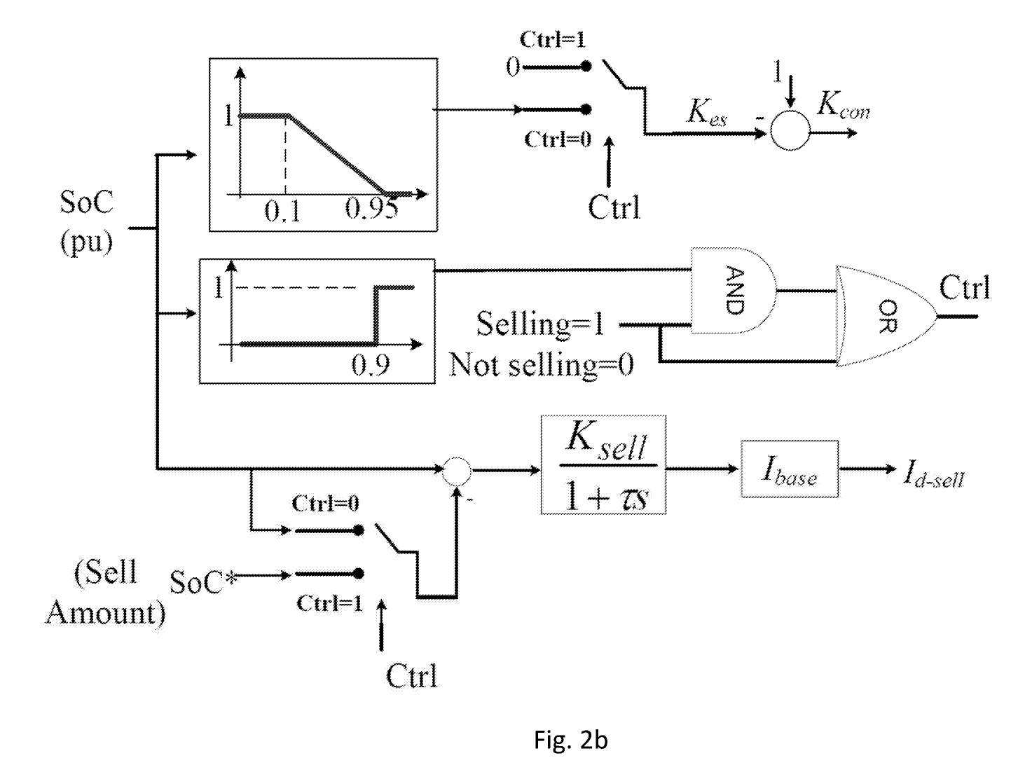

FIGS. 2a and 2b show the manner of operation of the controller 112. The DC/DC converter is controlled to perform maximum power point tracking (MPPT). In this embodiment, the exact means of MPPT is using the method proposed in M. Fazeli, P. Igic, P. M. Holland, R. P. Lewis, and Z. Zhou, “Novel Maximum Power Point Tracking with classical cascaded voltage and current loops for photovoltaic systems,” presented at the IET Conference Renewable Power Generation RPG Edinburgh, UK, 2011. This document is hereby incorporated by reference where permissible.

The proposed EMS, which is illustrated in FIG. 2b, creates three gains according to the SoC of the EM 108, those being:
Kₑₛ—ES gain;
K_{con}=1−Kₑₛ—DC/AC converter gain; and,
I_{d-sell}—selling current (power) gain.

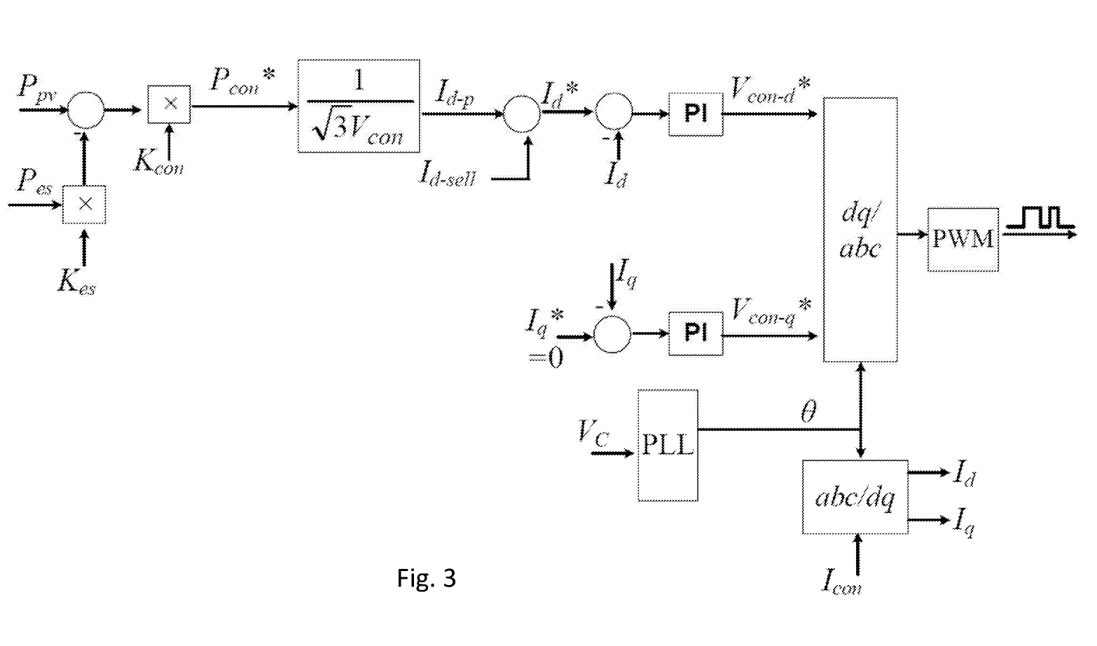

The gains are used according to the following method:
As shown in FIG. 1, Kₑₛ, K_{con} and I_{d-sell} are fed into the DC/AC converter controller 114, illustrated in detail in FIG. 3;
Kₑₛ and K_{con} are used to share Pₚᵥ between Pₑₛ and P_{con} (Kₑₛ+K_{con}=1);
   Therefore Pₚᵥ=Pₑₛ+P_{con} (this neglects the converter's losses i.e. for the purposes of this description, P_{dc}=P_{con}. It will be understood that in reality P_{con}<P_{dc}):
The operation of the DC/AC controller 114 is based on the power balance: P_{con}=K_{con}(Pₚᵥ−Kₑₛ·Pₑₛ). Referring to the upper branch of FIG. 2b, with Ctrl=0:
   For a low charge level, SoC<a predetermined “low” threshold (10% in this embodiment). In this condition, Kₑₛ=1, hence K_{con}=0 and Pₚᵥ=Pₑₛ.
   For a high charge level, SoC>a predetermined “high” threshold (95% in this embodiment), Kₑₛ=0, hence K_{con}=1 and Pₚᵥ=P_{con}.
   For charge levels between the thresholds, 10%<SoC<95%, Kₑₛ varies linearly with SoC. As SoC decreases, Kₑₛ increases. Pₚᵥ is split between Pₑₛ and P_{con}, proportional to Kₑₛ and K_{con}.
The d-component current I_{d-p} (FIG. 3) is calculated using P_{con*}=\sqrt{3}|V_{con}|I_{d}PF_{con}, (note I_{q}=0) where, V_{con} and PF_{con} are the converter AC-side voltage and power factor respectively. At steady state V_{con}≈1 pu and PF_{con}≈1.
The reference d-component current I_{d}*=I_{d-p}+I_{d-sell}, where I_{d-sell} is determined by the owner/operator of the DG through how much of the stored energy they want to sell.
   For SoC>a predetermined “energy release option” threshold, which should be less than or equal to the “high” threshold above (90% in this embodiment), the owner will be informed that they have the option to sell some of their stored energy. If they decide to sell, a reference SoC* will be created according to the amount of the energy they want to sell. If the option is taken to feed stored energy into the grid, the control signal is set to Ctrl=1. This affects the top branch of FIG. 2b by setting Kₑₛ=0, which means K_{con}=1 so Pₚᵥ=P_{con} (i.e. all PV power is routed into the main grid).
   A proportional controller Kₛₑₗₗ is used to control SoC. A low bandwidth filter is used to make sure that P_{con} does not jump (hence, avoiding voltage jump).
   When SoC=SoC* (which, as discussed above is based on the amount of energy the owner wants to sell) the owner has the option to either continue at SoC* or choose the not selling option, which makes Ctrl=0, and Pₚᵥ will be shared by Pₑₛ and P_{con} according to the current SoC (as above).

It will be noted that the thresholds mentioned above (high/low/energy release) can either be predefined or dynamically controlled by the DG user or by an algorithm which reflects the optimum user requirements or the practical limitations of the ES or the national grid regulations.
The output of the SoC controller is multiplied by the base current (I_{base}) to get I_{d-sell} in Amps.
I_{d-sell} is added to I_{d-p} to constitute the reference d-component current I_{d}*.
Standard PI controlled current loop are used to determine dq-components of converter voltage which are transformed to 3-phase frame using a Park Transform, to get the PWM signal (FIG. 2a).

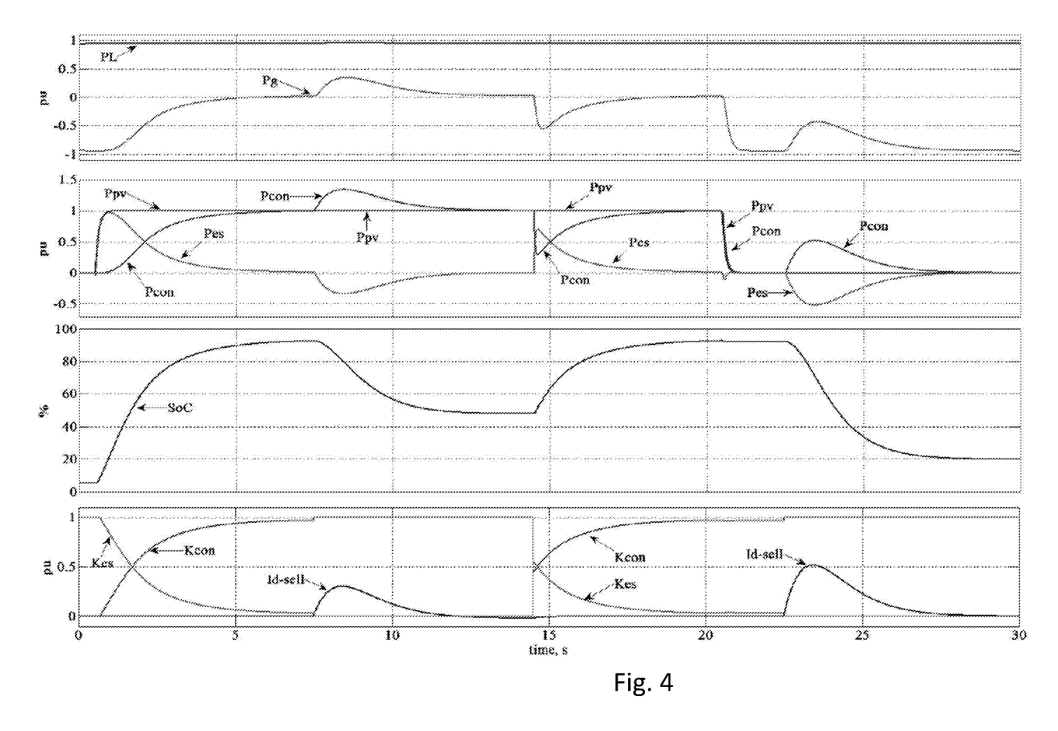

The proposed energy management system has been simulated with the following model:
The EMS shown in FIGS. 1 to 3 was simulated in PSCAD/EMTDC environment. The results are presented in FIG. 4, in which:
   The top graph shows Load Power (P_{L}) and grid power (P_{g}) vs. time;
   The second graph shows PV power (Pₚᵥ), DC/AC converter power (P_{con}) and ES power (Pₑₛ) (pu) vs. time;
   The third graph shows the state of charge vs. time; and,
   The lowest graph shows the various controller parameters vs. time.
At t=0
   PL=1 pu, Pₚᵥ=0, hence P_{g}=−1 pu.
   SoC=7%, hence, Kₑₛ=1, K_{con}=0.
At t=0.5 s
   Pₚᵥ=1 pu.
   Since SoC<10%, at first Pₑₛ=Pₚᵥ.
   As SoC increases, Pₑₛ reduces and P_{con} increases until when SoC=95%, Pₑₛ=0 and P_{con}=Pₚᵥ.
   For SoC>90% (sell option threshold), the owner has the option to sell the stored energy.
At t=7.5 s
   The owner decides to sell up to SoC*=50%. Ctrl=1, P_{con} increases and Pₑₛ reduces until SoC=50%.
   If the owner does not change the selling status, the SoC will remain at SoC*.
At t=14 s
   The owner chooses “not selling” option.
   Hence Ctrl=0.
   Hence, Pₚᵥ is shared between Pₑₛ and P_{con} according to Kₑₛ and K_{con}.
   As SoC increases, Pₑₛ reduces and P_{con} increases until when SoC=95%, P_{con}=Pₚᵥ and Pₑₛ=0.
At t=21 s
   Pₚᵥ=0, hence, P_{con}=0 and Pg=PL=1 pu.
At t=22.5
   The owner decides to use the stored energy down to SoC*=20%

It will be noted that the DC to DC converter used in the present invention is significantly lower cost than the equivalent AC to DC converter in prior art configurations. In addition, by making a parallel (as opposed to series) connected between the PV panels, energy storage and inverter, the ability is provided to share Pₚᵥ according to the SoC and desired level of stored energy in a flexible manner.

Energy Management System for Universal and Seamless Control of Microgrids

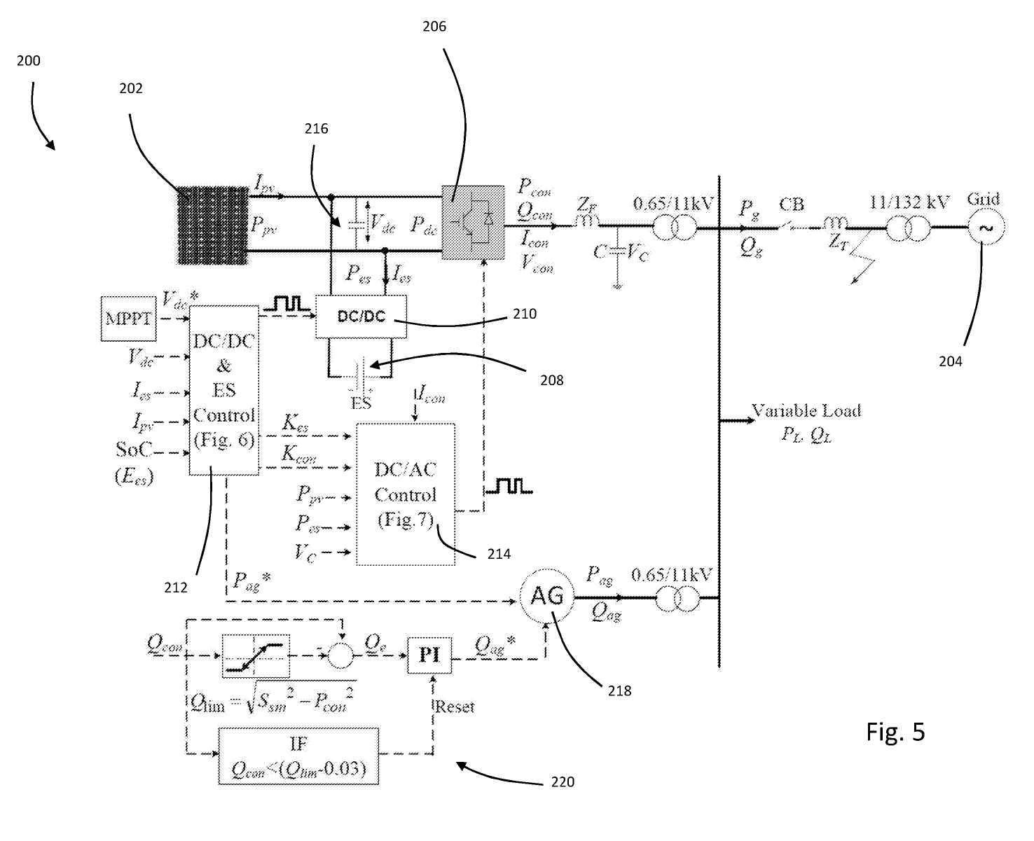

Referring to FIGS. 5 to 13, an energy management system in accordance with the present invention will be described. In particular, the system is well suited to handling transitions between grid connected and islanded states.

An energy management system 200 is shown in FIG. 5. The skilled addressee will note the similarities between the system 200 and the system 100. The system 200 is connected to a photovoltaic panel 202 at a first, upstream side and to a main electricity grid 204 at a second, downstream side.

The system 200 comprises:
A solar inverter 206;
An energy storage (ES) 208 in the form of a battery;
A DC/DC converter 210;
An auxiliary generator (AG) 218;
A first controller 212 controlling the DC/DC converter and an AG 218 (see below);
A second controller 214 controlling to the DC/AC converter (i.e. the solar inverter 206); and,
A third controller 220 controlling the AG 218.

It will be understood that the three controllers above are described separately for the sake of clarity, but they form a single “control system” whose functions may be performed by a single unit, or several distributed units as required.

As with the system 100, it will be noted that the energy storage 208 is positioned upstream of the inverter 206.

First Controller 212—DC/DC and ES Control

The ES 208 is connected to the DC link of the PV system through the DC/DC converter 210. The DC/DC converter 210 is controlled by the controller 212 to track maximum PV power. As with the system 100, the maximum power point tracking (MPPT) used in this embodiment is described in M. Fazeli, P. Igic, P. M. Holland, R. P. Lewis, and Z. Zhou, “Novel Maximum Power Point Tracking with classical cascaded voltage and current loops for photovoltaic systems,” presented at the IET Conference Renewable Power Generation RPG Edinburgh, UK, 2011. This document is hereby incorporated by reference where permissible. It will be noted that other MPPT methods may also be used in the present invention.

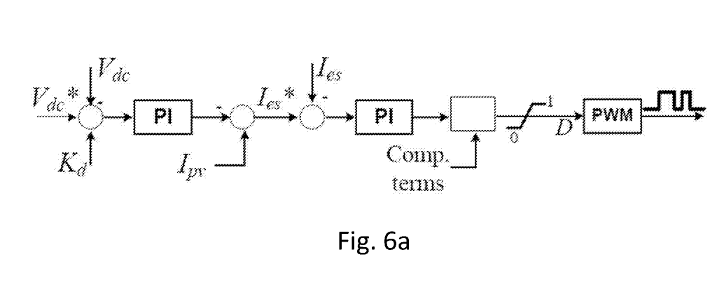

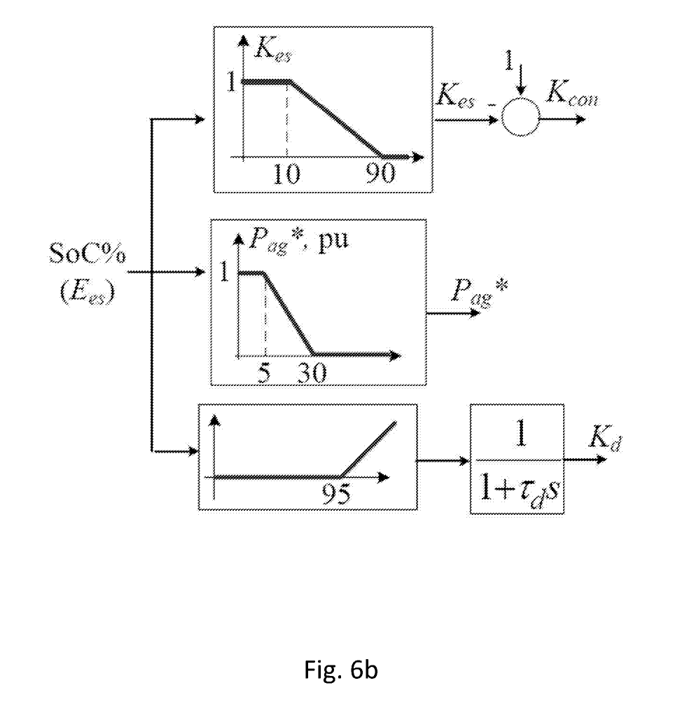

FIGS. 6a and 6b show the DC/DC converter control (via controller 112), which uses the classical cascaded voltage and current loops, developed in the above referenced paper, to control the DC-link voltage V_{dc} to follow its reference (V_{dc}*) from the MPPT algorithm.

FIG. 6b illustrates the proposed energy management system (EMS) according to the level of battery's state of the charge (SoC). The EMS operates through defining four variable gains based on the level of SoC.

As with the system 100, the combined cooperation of EG gain (Kₑₛ) and converter gain (K_{con}=1−Kₑₛ) determines how much of the generated PV power (Pₚᵥ) is stored in ES or being passed through the DC/AC converter 206. This is shown with reference to the upper branch of FIG. 6b. When SoC is more than a predetermined “high” threshold (in this embodiment 90%), all Pₚᵥ must go through the DC/AC converter 206 and for SoC less than a predetermined “low” threshold (in this embodiment 10%) all Pₚᵥ will go to the ES. Between those points, the distribution varies linearly. Hence, if:
SoC>90%→Kₑₛ=0 and K_{con}=1
SoC<10%→Kₑₛ=1 and K_{con}=0
10%<SoC<90%→Kₑₛ and K_{con} vary linearly between the two points, as shown in FIG. 6b.

Note that these thresholds are merely examples and they can change according to the preferences of owner/operator of the DG (e.g. how much they want to store in ES determines the “high” threshold), practical limitations on ES mechanisms, and the defined regulations and standards.

In islanded mode if load power P_{L}>Pₚᵥ, SoC keeps reducing (i.e. the ES is being discharged). At some point, the auxiliary generator (AG) needs to be used. The AG is controlled by the AG power demand signal P_{ag}*. Generation of the AG power demand signal P_{ag}* is shown in the middle branch of FIG. 6b. When SoC becomes less than an AG power demand threshold (which must be more than the “low” threshold of Kₑₛ e.g. in this embodiment 30%, being greater than 10%), a power demand signal P_{ag}* will be sent to the AG. For SoC less than a discharge prevention threshold (in this embodiment 5%), P_{ag}*=1 pu. Between the discharge prevention threshold and the AG power demand threshold, P_{ag}* varies linearly with SoC.

In islanded mode if load power P_{L}<Pₚᵥ, SoC keeps increasing (i.e. the PV panels 202 are generating more power than required by the load). Thus, measures must be taken into account to make sure that the ES will not get over-charged. Prior art solutions propose a “dumping” resistor to dissipate the extra generated energy. This is clearly inefficient and wasteful. The present invention acts to instead reduce generation rather than dumping power. The present invention deals with this as shown in the lower branch of FIG. 6b. As SoC increases more than an overcharge prevention threshold (which must be higher than Kₑₛ high threshold—e.g. 95% being higher than 90%), a gain (K_{d}) is generated and is added to V_{dc}* (FIG. 6a). Since, V_{dc}* is the voltage at which Pₚᵥ is at its maximum point, Pₚᵥ will be reduced by increasing V_{dc}* with K_{d}. The rate at which K_{d} increases depends on the Pₚᵥ−V_{dc} characteristic of the PV array. As shown in FIG. 6b, a first order filter is used to add a dynamic to the system and helps to damp the oscillations (τ_{d}=0.05 in this embodiment).

Second Controller 214—DC/AC Control

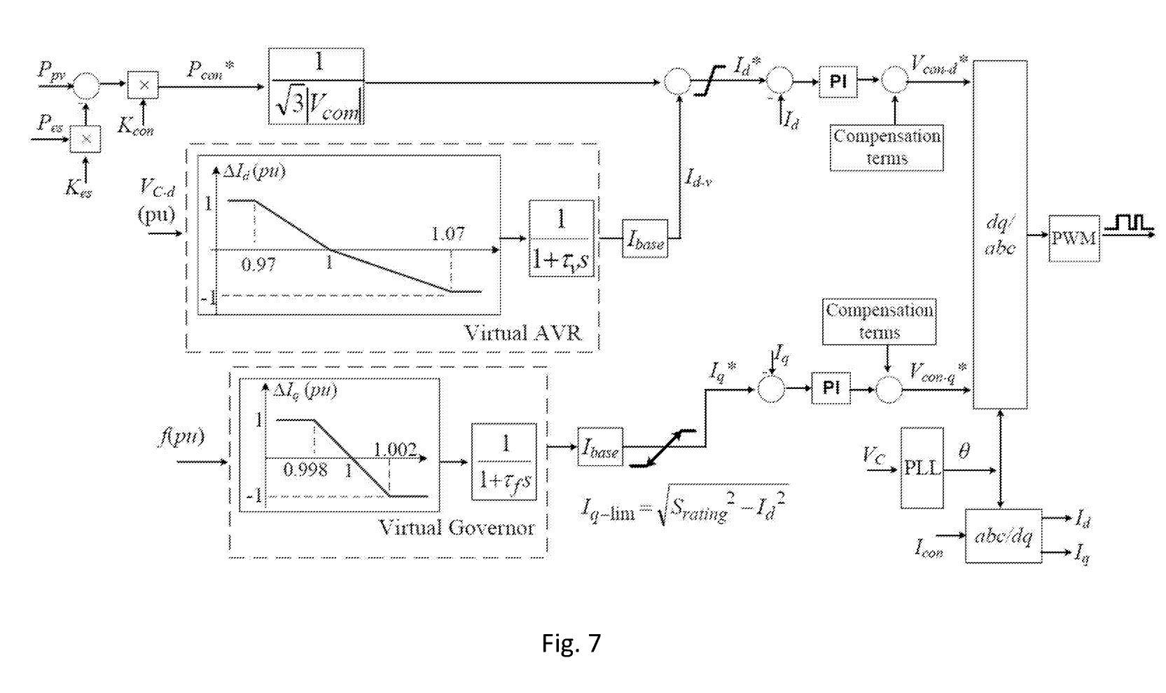

FIG. 7 illustrates the proposed control system for the second controller 214 controlling the DC/AC converter shown in FIG. 1. The control, which is based on the standard d-q current controllers aims to:

1. Control the Power Through DC/AC Converter P_{con}

As discussed above, Pₚᵥ=Pₑₛ+P_{dc} (neglecting the converter's loss, we assume P_{dc}=P_{con}). In order to take into account SoC, a reference converter power is defined as: P_{con}*=K_{con}(Pₚᵥ−Kₑₛ·Pₑₛ) Therefore whenever:
SoC>90%→P_{con}*=1(Pₚᵥ−0 Pₑₛ)=Pₚᵥ
SoC<10%→P_{con}*=0(Pₚᵥ−1 Pₑₛ)=0→Pₑₛ=Pₚᵥ
10%<SoC<90%→Pₚᵥ will be shared between ES and the 206 according to SoC.

Neglecting I_{d-v} for now, the reference d-component current I_{d}* (FIG. 7) will be calculated using P_{con}*=\sqrt{3}|V_{con}|I_{d}* PF_{con}, where, V_{con} and PF_{con} are the inverter AC-side voltage and power factor respectively. At steady state PFcon≈1, hence,

$${I}_{d}^{*} = \frac{{P}_{con}^{*}}{\sqrt{3} \vert {V}_{con} \vert} .$$

2. Control/Support Frequency

The proposed method, shown in FIG. 5, is used in both grid-connected and islanded operations; hence, there is no need for an islanding detection method. Moreover, since PLL remains as part of the islanding operation, there is no need for any communication between the grid and DG. The proposed method utilises the combined DG-ES-AG similar to a prime-mover in a conventional synchronous generator. The principal of the operation is explained below:

Steady State

The present invention uses a synchronously-reference-frame (SRF)-PLL, which is the most common PLL explained in literature such as S. Golestan and J. M. Guerrero, “Conventional Synchronous Reference Frame Phase-Locked Loop is an Adaptive Complex Filter,” IEEE Transactions on Industrial Electronics, vol. 62, No. 3, 2015 (hereby incorporated by reference where permitted). It will be understood that other types of PLL may be implemented.

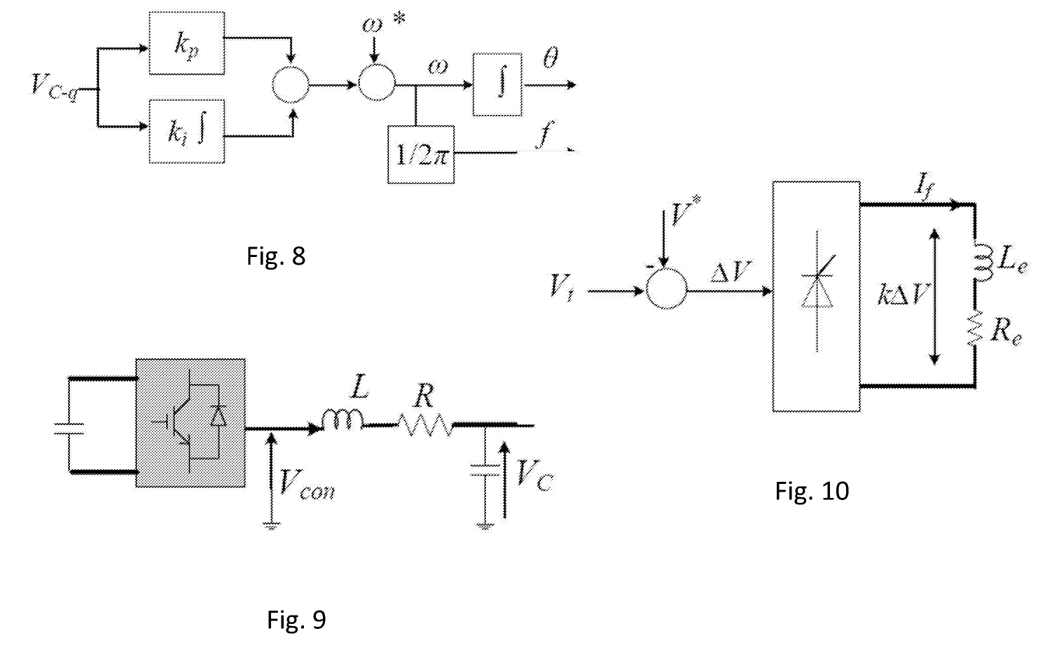

As shown in FIG. 8, the PLL measures frequency through keeping the q-component of filter voltage V_{C-q}=0. Neglecting the filter losses, according to Park Transform:

P_{con}=3/2(V_{C-d}I_{d}+V_{C-q}I_{q})

Q_{con}=3/2(V_{C-d}I_{d}+V_{C-d}I_{d}) (Eq. 1)

Therefore, at steady state when V_{C-q}=0 and V_{C-d}≈1 pu, active power is proportional to I_{d} and reactive power is proportional to I_{q}. Since the DC-link voltage of the DG is controlled by the ES, after grid disconnection, DG-ES appears as a current source to the local loads. In other words, the local loads impose I_{d} and I_{q} at steady state. Since PLL remains as part of the control in islanding operation, P_{con} and Q_{con} remain proportional to I_{d} and I_{q}, at steady state (V_{C-q}=0).

Transient

During transient since V_{C-q}≠0, both I_{d} and I_{q} can be used. However I_{d} and I_{q} exhibit different characteristics in respect to frequency variations. Considering FIG. 9, the following equations can be written using KVL and Park Transform:

V_{con-d}=V_{C-d}+I_{d}(R+sL)−LωI_{d} (Eq. 2)

V_{con-q}=V_{C-q}+I_{q}(R+sL)−LωI_{q} (Eq. 3)

Where, R and L are filter's resistance and inductance respectively.

According to FIG. 8, one can write:

$${V}_{C \text{-} q} ( {k}_{p} + \frac{{k}_{i}}{s} ) + {ω}^{*} = ω \to {V}_{C \text{-} q} = \frac{ω - {ω}^{*}}{{k}_{p} + \frac{{k}_{i}}{s}} \qquad ( Eq . 4 )$$

Where ω and ω′ are the reference frequency and measured frequency in rad/s, and kₚ and kᵢ are proportional and integral gains of PLL's PI controller. Since according to (Eq. 4) V_{C-q} is a function of frequency, (Eq. 3) seems more suitable for investigating frequency variations, while (Eq. 2) seems a better equation for investigating the variation of voltage:

Substituting (4) into (3) and solving it for I_{d} gives:

$${I}_{d} = \frac{{v}_{con - q}}{L ω} - \frac{1}{L ( {k}_{p} + \frac{{k}_{i}}{s} )} + \frac{{ω}^{*}}{L ω ( {k}_{p} + \frac{{k}_{i}}{s} )} - \frac{{I}_{q} ( R + sL )}{L ω} \to \frac{\partial {I}_{d}}{\partial ω} = \frac{- {v}_{con - q}}{L {ω}^{2}} - \frac{{ω}^{*}}{L {ω}^{2} ( {k}_{p} + \frac{{k}_{i}}{s} )} - \frac{{I}_{q} ( R + sL )}{L {ω}^{2}} \qquad ( Eq . 5 )$$

Substituting (4) into (3) and solving it for I_{q} gives:

$${I}_{q} = \frac{{v}_{con - q}}{( R + sL )} - \frac{ω}{( R + sL ) ( {k}_{p} + \frac{{k}_{i}}{s} )} + \frac{{ω}^{*}}{( R + sL ) ( {k}_{p} + \frac{{k}_{i}}{s} )} - \frac{L ω {I}_{d}}{( R + sL )} \to \frac{\partial {I}_{q}}{\partial ω} = \frac{- 1}{( R + sL ) ( {k}_{p} + \frac{{k}_{i}}{s} )} - \frac{{LI}_{d}}{( R + sL )} = \frac{- 1}{( R + sL )} ( \frac{1}{( {k}_{p} + \frac{{k}_{i}}{s} )} + {LI}_{d} ) \qquad ( Eq . 6 )$$

Equation (Eq. 5) shows that

$$\frac{\partial {I}_{d}}{\partial ω}$$

is inversely proportional to ω². In other words, as frequency increases, the sensitivity of I_{d} to change of frequency reduces. On the other hand, according to (Eq. 6),

$$\frac{\partial {I}_{q}}{\partial ω}$$

is independent of frequency variation. Therefore, it can be concluded that I_{q} is a better option to control frequency than I_{d}. This may seem contradictory to the well-known fact that (in an inductive system) frequency is proportional to active power. However, it is noted that |I_{con}|=\sqrt{(I_{d}²+I_{q}²)} and since active power is in fact proportional to |I_{con}|, both I_{d} and I_{q} can be used to control active power during transient (note V_{C-q}≠0). It is also noted that although

$$\frac{\partial {I}_{q}}{\partial ω}$$

is a function of I_{d}, since inductance L is relatively small and LωI_{d} is added to I_{q} current control loop as a compensation term; the effect of I_{d} can be ignored, hence,

$$\frac{\partial {I}_{q}}{\partial ω}$$

will be mainly effected by the dynamics of PLL (i.e. kₚ and kᵢ). Equation (Eq. 7) explains the proposed I_{q-f} droop which is illustrated in FIG. 7:

ΔI_{q}=K_{f}(f−f*) (Eq. 7)

Where f*=1 pu (50 Hz in the UK), K_{f} is droop gain. K_{f} is determined according to the acceptable frequency deviations which is different according to different standards e.g. it is ±0.1 Hz in the Northern EU, ±0.2 Hz in Continental EU, and ±0.5 Hz in Australia. In this embodiment the most restricted standard which is ±0.1 Hz (=±0.002 pu taking 50 Hz as base) is illustrated, however, the skilled addresse will understand that variations are possible. K_{f} is set such that when frequency deviation is maximum, ΔI_{q}=±1 pu (K_{f}=−1/0.002=−500 pu).

3. Damp Oscillations

In prior art non-renewable systems, due to a relatively large inertia, the speed of a synchronous generator (and hence frequency) does not change very quickly. Moreover, due to existence of losses (friction and damper bars), any oscillations after a disturbance get damped (assuming stable operation). In order to add a similar dynamic and damping characteristic to the control paradigm of the present invention, a first order low pass filter is augmented to the output of the proposed I_{q-f} droop (FIG. 7). The following demonstrates that the augmented first order filter exhibits similar characteristics to the dynamics of a synchronous generator:

The rotor dynamics of a synchronous generator is described by swing equation:

Pₘ−Pₑ=M\ddot{δ}+D\dot{δ} (Eq. 8)

Where, Pₙ, and Pₑ are mechanical input power from prime-mover (in pu) and the generated electrical power (in pu) respectively. M is angular momentum which in pu

$$M = \frac{H}{π f} ,$$

H is inertia constant D is damping factor and δ is rotor angle. It is known that Δ\dot{δ}=Δω where ω=2πf, hence equation (Eq. 8) can be rewritten as:

Pₘ−Pₑ=M\dot{ω}+Dω→ΔP=MΔ\dot{ω}+DΔω (Eq. 9)

In the Laplace domain:

$$Δ P = Ms Δω + D Δω \to Δω = \frac{Δ P}{Ms + D} \to Δ f = \frac{Δ P}{2 π D ( \frac{M}{D} s + 1 )} \qquad ( Eq . 10 )$$

Considering (Eq. 7), the output of the proposed virtual governor, illustrated in FIG. 7, is:

$$f - {f}^{*} = Δ f = \frac{{I}_{q}}{{K}_{f} ( {τ}_{f} s + 1 )} \qquad ( Eq . 11 )$$

Comparing (Eq. 11) with (Eq. 10), τ_{f} is proportional to M/D. H is normally between 1 and 10 pu, which makes M=0.0064-0.064 pu (f=50 Hz). Assuming D=0.1 pu, τ_{f}=0.064-0.64 pu.

The output of the virtual governor is multiplied by base current (I_{base}) and then is limited using a variable hard limit which varies according to I_{q-lim}=\sqrt{S_{rating}²−I_{d}²}. S_{rating} is the rated apparent power of the DG's converter. It is noted that at steady state I_{q} is proportional to reactive power, which is relatively small. If converter capacity is not sufficient to supply load reactive power Q_{L}, AG will supply the difference, which will be discussed below.

4. Control/Support Voltage

In a prior art/non-renewable synchronous generator an automatic voltage regulator (AVR) is used to control the terminal voltage of the generator (Vₜ) through varying its excitation current (I_{f}). FIG. 7 proposes a virtual AVR which augments I_{d} from power control scheme by I_{d-v} to form I_{d}*.

As discussed above, since at steady state V_{C-q}=0, P and Q are proportional to I_{d} and I_{q} respectively. However, during transient since V_{C-q}≠0, both I_{d} and I_{q} can be used to control P and Q. The following demonstrates that I_{d} (compared to I_{q}) is a better option for controlling voltage:

Equation (Eq. 2) can be rewritten as:

ΔV_{d}=I_{d}(R+sL)−LωI_{q} (Eq. 12)

Where, ΔV_{d} is the d-component of the voltage drop across the filter's impedance. Solving (Eq. 12) for I_{q} gives:

$${I}_{q} = \frac{{I}_{d} ( R + sL )}{L ω} - \frac{Δ {V}_{d}}{L ω} \to \frac{\partial {I}_{q}}{\partial Δ {V}_{d}} = \frac{- 1}{L ω} \qquad ( Eq . 13 )$$

Solving (Eq. 12) for I_{d} gives:

$${I}_{d} = \frac{{I}_{q} L ω}{( R + sL )} + \frac{Δ {V}_{d}}{( R + sL )} \to \frac{\partial {I}_{d}}{\partial Δ {V}_{d}} = \frac{1}{( R + sL )} \qquad ( Eq . 14 )$$

Equation (Eq. 13) demonstrates that

$$\frac{\partial {I}_{q}}{\partial Δ {V}_{d}}$$

is inversely proportional to ω. Therefore, as frequency increases, the sensitivity of I_{q} to voltage variations reduces. However according to (14),

$$\frac{\partial {I}_{d}}{\partial Δ {V}_{d}}$$

only depends on filter's impedance. Hence, I_{d} is a better option for controlling voltage.

Equation (Eq. 15) explains the proposed I_{d-v} droop illustrated in FIG. 7:

ΔI_{d}=Kᵥ(V−V*) (Eq. 15)

Where, V and V* are the measured and reference voltages (V*=1 pu), Kᵥ is the voltage droop gain. Kᵥ is determined according to standard voltage variation i.e. 0.94 pu<V<1.1 pu. Assuming 3% voltage drop on transformers, voltage variation used FIG. 7 will be: 0.97 pu<V<1.07 pu. Kᵥ is defined such that when V=0.97 pu, ΔI_{d}=1 pu; and when V=1.07 pu, ΔI_{d}=−1 pu:Kᵥ=−33.33 pu for V<1 pu, and Kᵥ=−14.28 pu for V>1 pu.

Similar to the virtual governor, the output of the Id-V droop is passed through a first order low-pass filter in order to add dynamics and damping characteristic to the system.

FIG. 6 shows a simplified diagram of a static AVR system where, Rₑ and Lₑ are the resistance and inductance of the synchronous generator's excitation winding; V* and Vₜ are the reference and terminal voltage of the generator; and I_{f} is the excitation current.

It can be shown that the voltage across the excitation winding must be proportional to the voltage error i.e. ΔV. Thus:

$$K Δ V = {I}_{f} ( {R}_{e} + {sL}_{e} ) \to {I}_{f} = \frac{K Δ V}{{R}_{e} ( \frac{{L}_{e}}{{R}_{e}} s + 1 )} \qquad ( Eq . 16 )$$

According to (15), the output of the proposed virtual AVR, shown in FIG. 7 is:

$${I}_{d - v} = \frac{{K}_{v} ( V - {V}^{*} )}{1 + {τ}_{v} s} \qquad ( Eq . 17 )$$

Comparing (17) with (16) demonstrates that τᵥ is proportional to Lₑ/Rₑ. An AVR system is much faster than a governor, hence, τᵥ=0.02-0.1 pu is appropriate in this embodiment.

Third Controller 220—AG Control

The AG is a fossil-fuelled generator (e.g. a microturbine). Hence, the idea is to minimise its usage.

Active power control of AG is illustrated in FIG. 1 and FIG. 6b. In this embodiment, the AG does not make any contribution in load active power P_{L} during grid-connected mode (although it is possible to do so, if required). Hence, the load is shared between DG and the grid. The ratio of sharing depends on generated solar energy and how much energy the owner of DG wants to store (here assumed 90%, based on the predetermined “high” threshold in the upper branch of FIG. 6b).

In islanded mode the load is mainly supplied by the DG-ES.

Since SoC is an indicator of shortage (or excess) of energy, for SoC<the AG power demand threshold (30% in this embodiment, as discussed above) a demand signal will be sent to the AG which increases as SoC drops such that when SoC is at the discharge prevention threshold=5%, Pag*=1 pu. It is also possible to use load shedding schemes prior to bringing in the AG in order to supply only the “critical loads” by the AG.

In this embodiment the DG's converter does not make any contribution in load reactive power Q_{L} during grid-connection mode (assuming a strong grid). However if required, it is possible to augment the reference I_{q}* form the virtual governor with another reference to supply part of Q_{L}.

During islanded operation, Q_{L} will be automatically supplied by the converter. Since both P_{L} and Q_{L} are (initially) supplied by the DG-ES, measures must be taken into account to make sure that the DG's converter rating S_{ratting} is not violated. In order to achieve this, it is proposed in FIG. 5 to utilise the AG when Q_{L} is high. As shown in FIG. 1, Q_{con} is limited using a variable hard limit which varies according to Qₗᵢₘᵢₜ=\sqrt{Sₛₘ²−P_{con}²} (since P_{con} changes, a variable hard limit is needed), where Sₛₘ=S_{rating}−3% (3% is the proposed safety margin). Then, the limited Q_{con} is subtracted from Q_{con} to constitute the error reactive power Qₑ (hence, as long as Q_{con}<Qₗᵢₘᵢₜ→Qₑ=0). Qₑ is controlled to zero using a PI controller actuating the reference AG's reactive power Q_{ag}*. The integrator of the PI controller will be rest when Q_{con}<(Qₗᵢₘᵢₜ−0.03 pu), 0.03 pu is a suggestion to make sure that Q_{con}<<Qₗᵢₘᵢₜ, hence, avoiding possible oscillation. If the integrator is not reset, Q_{L} will be shared by the converter and the AG even when QL<Qₗᵢₘᵢₜ.

Results

The model shown in FIG. 5 was simulated in PSCAD/EMTDC environment. The PV converter's S_{rating}=1.1 pu (based on PV array rating). Considering 3% safety margin Sₘₜ=1.07 pu. The AG is simulated by a 3-phase current source. The rest of the parameters are given in Table I.

| Variable | Value(s) |
|---|---|
| Filter impedance Zf | R = 1 mΩ |
| | L = 0.1 mH |
| Transformers' leakage reactance | 10% |
| Transmission line impedance Zt | R = 0.16 Ω |
| | L = 0.6 mH |
| Current loops PI controllers | Kₚ = 0.157 |
| | Kᵢ = 1.57 (pole placement) |
| τ_{f}, τᵥ and τ_{d} | 0.3 pu, 0.05 pu and 0.05 pu |
| AG's reactive power PI controller | Kₚ = 2 |
| | Kᵢ = 17 |
| PLL PI controller | Kₚ = 5 |
| | Kᵢ = 10 |

Two scenarios are simulated:

Scenario A. When During Islanding P_{PV}≤P_{L}

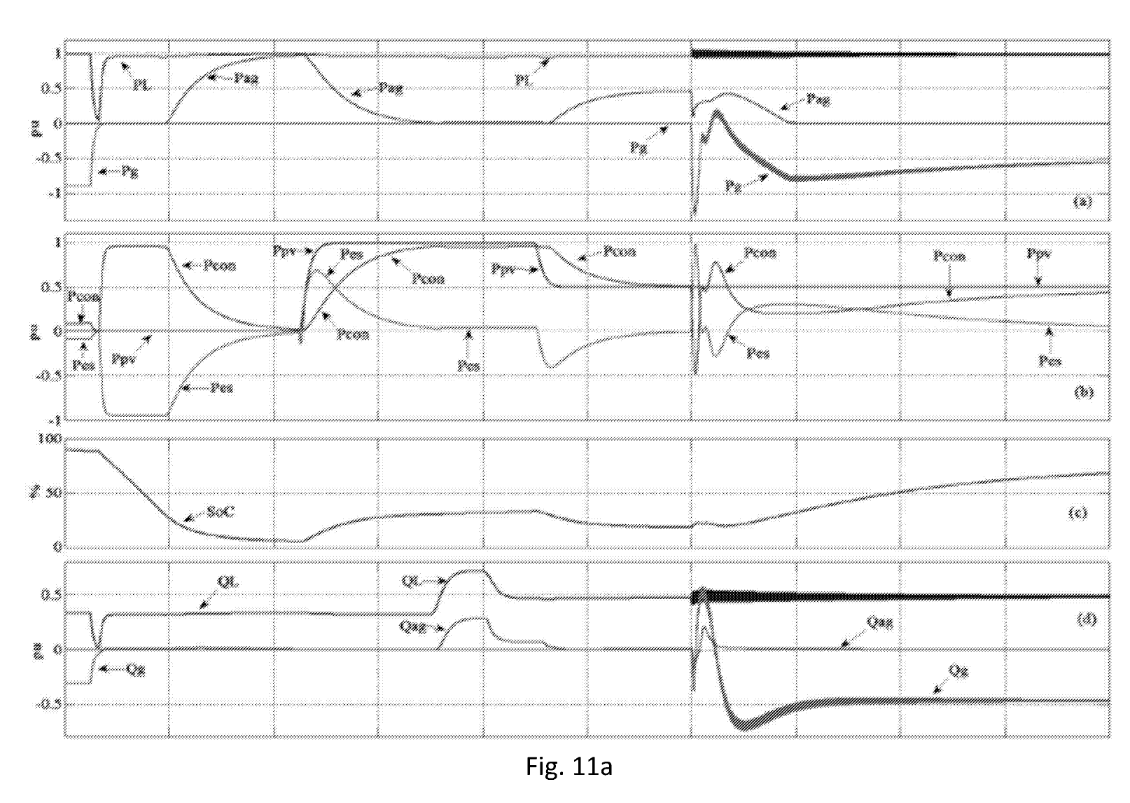

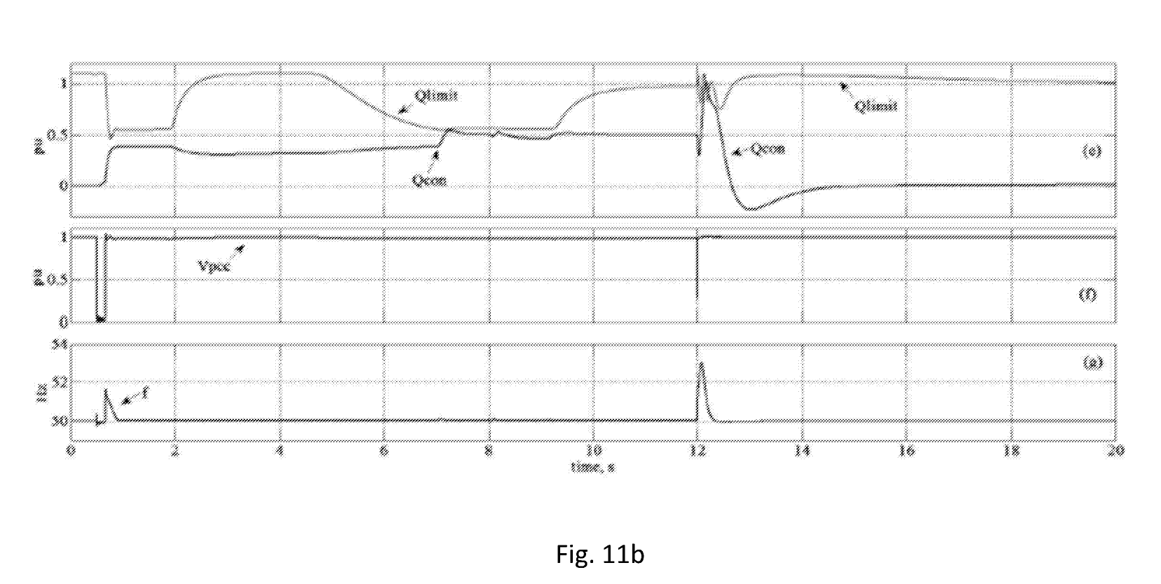

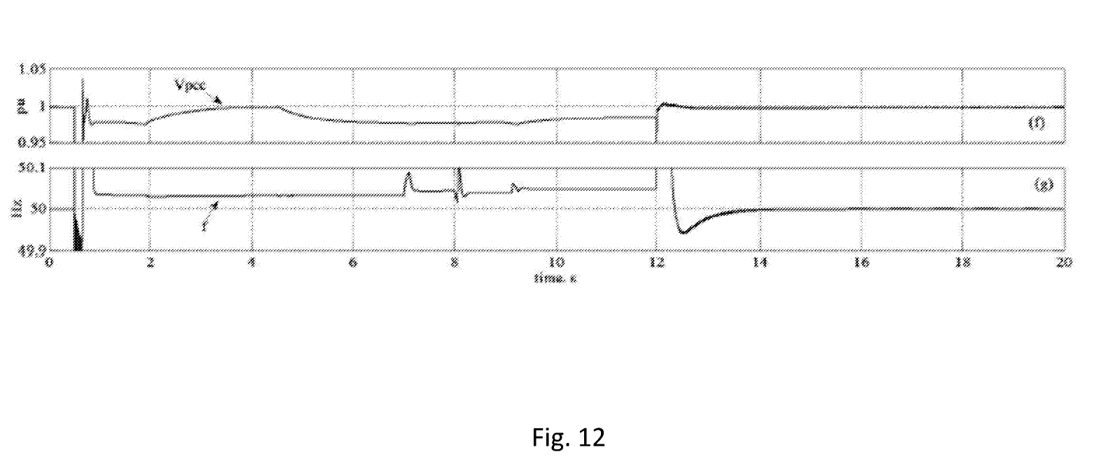

The simulation results are shown in FIGS. 11a and 11b. The simulation events are as follows:
t=0-0.5 s
   P_{L}=1 pu with PF=0.95 lagging. Since Pₚᵥ=0, the main grid supplies both load P_{L} (active power) and Q_{L} (reactive power). SoC starts at 90%. It is noted that since due to voltage drops on transformers and transmission line impedances, V_{C}<1 pu, the proposed virtual AVR uses the energy stored in ES to restore the voltage. In practical systems, this is normally done using transformer's tap changer; however, it was intentionally removed to demonstrate the ability of the present invention to support local voltage in case of weak grids.
t=0.5 s
   A 3-phase fault occurs at the grid-side and after 0.16 s (standard time for relay operation), the circuit breaker opens (CB in FIG. 5), islanding the micro grid.
t=0.5-125 (Islanded operation)
   The voltage of point of common coupling Vₚ and f are very well-controlled (note that just before the fault P_{L}=P_{g}=1 pu i.e. worst-case scenario in terms of power imbalance). It is noted that the reduction in P_{L} is due to a slight reduction in voltage (V_{pcc}=0.97 pu which is within acceptable limits). P_{L} is supplied by ES through P_{con} (See graph (b)) and Q_{L} is supplied by PV converter (Q_{con}, graph (e)). When SoC<30% (around t=25), P_{ag} increases to supply P_{L} (graph (a)). Using the proposed method, when SoC=5%, P_{ag}=P_{L}=1 pu. At t=4.5 s, Pₚᵥ increases to 1 pu. Since SoC<10%, first ES power Pₑₛ (graph (b)) increases, then as SoC increases, P_{con} increases which causes Pₑₛ and P_{ag} to reduce (note that due to V_{pcc}=0.97 pu, P_{L} is slightly less than 1 pu, hence, for Pₚᵥ=1 pu, some power is still available for ES). It is noted that Qₗᵢₘᵢₜ (graph (e)) drops as P_{con} increases. As a result, when at t=7 s, PF drops to 0.8 lagging, Q_{L}>Qₗᵢₘᵢₜ (graphs (d) and (e)). The proposed scheme makes sure that Q_{con} does not violate its limit (graph (e)) through supplying the difference by the AG Q_{ag} (graph (d)). At t=8 s, PF increases to 0.9 lagging, which causes Q_{L}, hence, Q_{ag} to reduce. However, since Q_{con} not less than (Qₗᵢₘᵢₜ−0.03 pu), the PI controller is not reset, leading to Q_{ag}≠0. At t=9 s, Pₚᵥ drops to 0.5 pu, SoC reduces to supply the shortage. Again when SoC<30%, P_{ag} increases to feed load. When P_{ag} supplies the load, P_{con} reduces which in turn causes to Qₗᵢₘᵢₜ to increase i.e. more capacity from the converter to supply reactive power. As a result, Q_{con}<(Qₗᵢₘᵢₜ−0.03 pu), which resets the PI controller, hence, Q_{ag}=0.
t=12 s (grid reconnection)
   C.B. is closed and voltage and frequency are restored. After a short transient (about 0.5 s), Q_{con}=Q_{ag}=0, Q_{g}=Q_{L}≈0.5 pu (PF=0.9 lag). As discussed, it is possible to supply part of Q_{L} using the converter if required. It can be seen than after reconnection, since SoC is less than 90%, first Pₑₛ increases. However, as SoC increases toward 90%, Pₑₛ reduces and P_{con} increases. It is emphasised again that the 90% threshold can be set by the owner/operator of the DG and theoretically can be any value.
   FIG. 12 shows the zoomed in voltage and frequency. As it can be seen, V_{pcc}>0.97 pu, and f<50.1 Hz, at steady state, during islanded operation.

Scenario B: When During Islanding P_{PV}>P_{L}:

It is possible (although unlikely) that Pₚᵥ>P_{L} for longer than the capacity of ES. In such cases different “dumping” mechanisms are introduced in literature such as using a dumping resistance. The invention proposes to reduce the generation through altering V_{dc}*, which is produced by MPPT algorithm, as illustrated in FIG. 6. Since V_{dc}* is a unique voltage (for each solar irradiance) at which Pₚᵥ is maximum, adding a gain (K_{d}) to it will reduce the generated power. It should be emphasised that the proposed dumping algorithm is not a necessary part of the proposed voltage and frequency control and any other dumping methods such as those introduced in can be used as well.

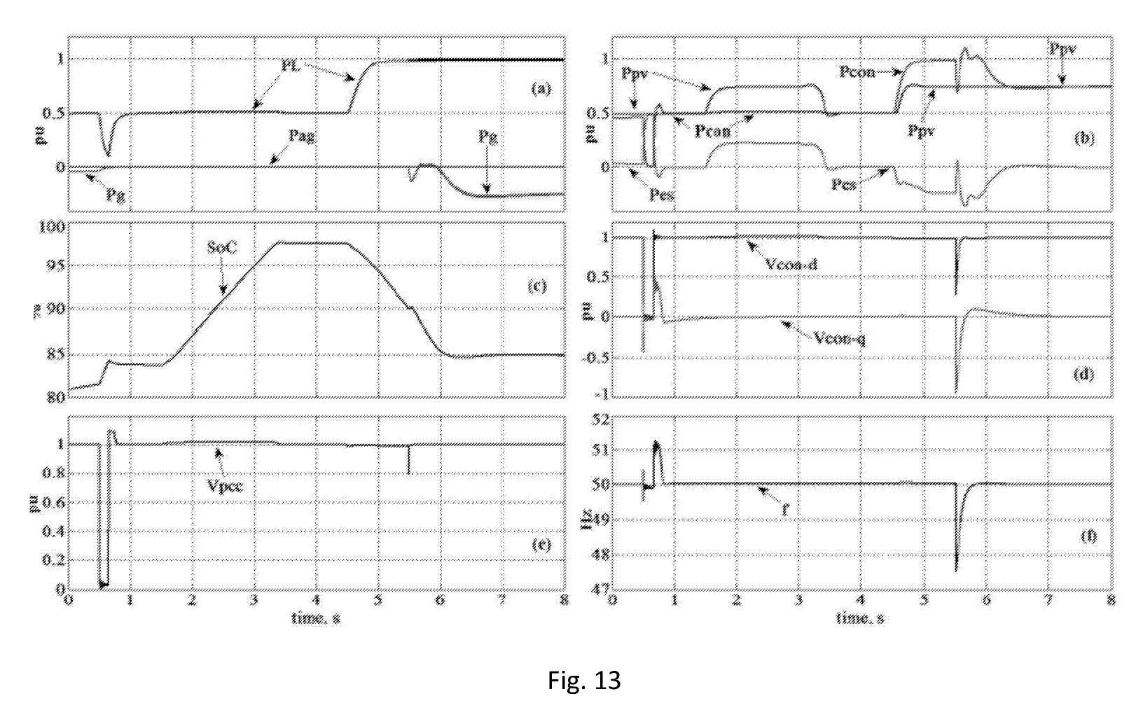

The simulation results are shown in FIG. 13:
t=0
   Initially Pₚᵥ=P_{L}=0.5 pu. Since SoC<90% (graph (c)), Pₚᵥ, is shared between P_{con} and Pₑₛ (graph (b)). However, since SoC is close to 90%, P_{con}≈Pₚᵥ>>Pₑₛ (graph (b)). The difference between P_{L} and P_{con} is supplied by P_{g} (graph (a)), until:
t=0.5 s
   a three-phase fault occurs, and after 0.16 s, the C.B. is opened. Hence, P_{con}=Pₚᵥ=P_{L}=0.5 pu.
t=1.5 s
   Pₚᵥ=0.75 pu. Since Pₚᵥ>P_{L}, the difference is stored in ES causing SoC to increase. Using the proposed voltage control in Fig. ?, I_{d-v} is reduced to keep V_{pcc} less than 1.1 pu as shown in graph (e).
t=3 s
   As SoC>95%, according to the proposed method, K_{d}, (the rate is 50) is added to V_{dc}* hence, Pₚᵥ reduces=P_{con}=P_{L}. As a result SoC remains constant at almost 98%.
t=4.5 s
   P_{L} increases to 1 pu, hence SoC reduces to compensate for the shortage which causes K_{d} to reduce, hence, Pₚᵥ returns back to its maximum value (0.75 pu).
t=5.5 s
   Grid is re-connected, hence, V and f are restored. Since SoC=85% (very close to 90%), P_{con}≈Pₚᵥ=0.75 pu (Pₑₛ≈0), and P_{g} supplies the difference.

Variations fall within the scope of the invention. The embodiment described above can be extended to other types of ES mechanisms where by the SoC can be replaced by other parameters such as voltage (for supercapacitors) or speed (for flywheels). Further, the invention can be applied to other energy harvesting devices e.g. windmills/wind turbines where there is conventionally a DC to AC converter with a downstream AC to DC converter to accommodate long term local energy storage. It is noted that if other types of ES systems are to be used, their energy level (Ees) can be used instead of SoC.

It will be understood that the a virtual automatic voltage regulator (AVR), virtual governor and phase-locked loop (PLL) elements of the system may be used separately, however the greatest advantage is in using the three elements together.

1. A micro-grid energy management system for operation in both grid-connected and islanded modes, the system comprising:
a power input connectable to a renewable, distributed energy generator;
a DC/AC inverter connectable to a main grid;
an energy storage unit;
a DC/DC converter between the energy storage unit and a DC side of the DC/AC inverter;
an auxiliary generator;
a control system configured to control the DC/AC inverter, DC/DC converter and AG, the control system comprising:
a virtual automatic voltage regulator configured to control an AC side voltage of the DC/AC inverter;
a virtual governor configured to receive frequency as input and to control a frequency of the DC/AC inverter; and,
a phase-locked loop configured to control a phase of the DC/AC inverter;
in which the virtual automatic voltage regulator, virtual governor and phase-locked loop are operational in both grid-connected and islanded conditions.

2. A micro-grid energy management system according to claim 1, in which at least one of the group consisting of virtual automatic voltage regulator and the virtual governor, use droop control.

3. A micro-grid energy management system according to claim 1, in which the virtual automatic voltage regulator is configured to control the AC side voltage using a d-component of current (I_{d}), and/or, in which the virtual governor is configured to control the frequency using a q-component of current (I_{q}).

4. (canceled)

5. A micro-grid energy management system according claim 1, in which the phase locked loop is a synchronous reference frame phase locked loop, and/or, in which the DC/DC converter is configured to track a maximum power of the power input using a maximum power point tracking algorithm, in which a DC link voltage (V_{dc}) across the power input follows a reference voltage (V_{dc}*) from the maximum power point tracking algorithm.

6. (canceled)

7. A micro-grid energy management system according to claim 1, in which the control system is responsive to a state of charge of the energy storage to control the DC/DC converter to selectively control a flow of power from the power input to the energy storage, and from the energy storage to the DC/AC inverter, and preferably in which the control system has a high threshold state of charge in which substantially all power from the power input is passed to the DC/AC inverter.

8. (canceled)

9. A micro-grid energy management system according to claim 7, in which the control system has a low threshold state of charge in which substantially all power from the power input is passed to the energy storage.

10. A micro-grid energy management system according to claim 7, in which the control system defines a variable energy storage gain (Kₑₛ) based on the state of charge of the energy storage, and in which the variable energy storage gain (Kₑₛ) controls a proportion of power from the power input which is (i) fed to the DC/AC converter and (ii) fed to the energy storage.

11. A micro-grid energy management system according to claim 7, in which the control system is configured to activate the auxiliary generator in the event that the state of charge of the energy storage falls below a predetermined auxiliary generator power demand threshold.

12. A micro-grid energy management system according to claim 7, in which the control system is configured to adjust a DC link reference voltage (V_{dc}*) to reduce power from the power input if the state of charge of the energy storage exceeds an overcharge prevention threshold.

13. A method of controlling a micro-grid energy management system for operation in both grid-connected and islanded modes, the method comprising the steps of:
providing:
a power input connectable to a renewable, distributed energy generator, a DC/AC inverter connectable to a main grid, an energy storage unit, a DC/DC converter between the energy storage unit and a DC side of the DC/AC inverter, and, an auxiliary generator;
controlling the DC/AC inverter, DC/DC converter and AG, using:
a virtual automatic voltage regulator configured to control an AC side voltage of the DC/AC inverter, a virtual governor configured to receive frequency as input and to control a frequency of the DC/AC inverter, and, a phase-locked loop configured to control a phase of the DC/AC inverter in both grid-connected and islanded conditions.

14. The method according to claim 13, comprising the further step of:
using droop control in the virtual automatic voltage regulator and/or the virtual governor.

15. The method according to claim 13, comprising the further step of:
using a d-component of current (I_{d}) to control the AC side voltage in the virtual automatic voltage regulator.

16. The method according to claim 13, comprising the further step of:
using the q-component of current (I_{q}) to control the frequency in the virtual governor.

17. The method according to claim 13, in which the phase locked loop is a synchronous reference frame phase locked loop.

18. The method according to claim 13, comprising the further step of:
tracking a maximum power of the power input using a maximum power point tracking algorithm using the DC/DC converter, in which a DC link voltage (V_{dc}) across the power input follows a reference voltage (V_{dc}*) from maximum power point tracking algorithm.

19. The method according to claim 13, comprising the further step of:
controlling the DC/DC converter to selectively control a flow of power from the power input to the energy storage, and from the energy storage to the DC/AC inverter based on a state of charge of the energy storage and preferably system has a high threshold state of charge in which substantially all power from the power input is passed to the DC/AC inverter.

20. (canceled)

21. The method according to claim 19, in which the control system has a low threshold state of charge in which substantially all power from the power input is passed to the energy storage.

22. The method according to claim 19, comprising the further step of:
controlling a proportion of power from the power input which is (i) fed to the DC/AC converter and (ii) fed to the energy storage based on a variable energy storage gain (Kₑₛ) based on the state of charge of the energy storage.

23. The method according to claim 13, comprising the further step of:
activating the auxiliary generator in the event that a state of charge of the energy storage falls below a predetermined AG power demand threshold.

24. The method according to claim 18, comprising the further step of:
adjusting the DC link reference voltage (V_{dc}*) to reduce power from the power input if the state of charge of the energy storage exceeds an overcharge prevention threshold.
